(19) United States
(12) Patent Application Publication
(10) Pub. No.: US 2026/0243116 A1
(43) Pub. Date: Aug. 20, 2026

(54) LOCK FOR A MOTOR VEHICLE, IN PARTICULAR HOOD LOCK OR PANEL LOCK

(71) Applicant: Kiekert Aktiengesellschaft, Heiligenhaus (DE)

(72) Inventors: Tomáš DANIHELKA, Prelouc (CZ); Jan SUK, Pardubice (CZ); Aleš KEJDANA, Prelouc (CZ); Matyas DALECKY, Kolín (CZ)

(73) Assignee: Kiekert Aktiengesellschaft, Heiligenhaus (DE)

(21) Appl. No.: 19/156,451

(22) PCT Filed: Jan. 15, 2024
(86) PCT No.: PCT/DE2024/100031

§ 371 Date: Aug. 25, 2025

(30) Foreign Application Priority Data
Feb. 15, 2023 (DE) 10 2023 000 508.8

(51) Int. Cl. E05B 83/24; E05B 15/04; E05B 85/02; E05B 85/24; E05B 85/26

(52) U.S. Cl. CPC E05B 83/24; E05B 85/02; E05B 85/243; E05B 85/26; E05B 2015/0434

(57) ABSTRACT

The invention relates to a method and a motor vehicle lock (1), in particular a hood lock, comprising a locking mechanism with a rotary latch (3) and at least one pawl (4) for latching a striker (8) at least in a locking position of the motor vehicle lock (1), and a torsion spring (7), wherein the torsion spring (7) interacts with the locking mechanism (3, 4) such that the striker can be moved out of the locking position by means of the torsion spring (7) at least in a supporting manner, wherein a different force can be introduced into the striker (8) by means of the torsion spring (7).

The invention relates to a lock for a motor vehicle, in particular a hood lock, comprising a locking mechanism having a rotary latch and at least one pawl for latching a striker at least in a locking position of the motor vehicle lock, and a torsion spring, wherein the torsion spring interacts with the locking mechanism such that the striker can be moved out of the locking position by means of the torsion spring at least in a supporting manner.

Locks or locking systems for motor vehicles are used where doors, hinged panels or movable components must be held on motor vehicles in order to ensure safe driving of the motor vehicle. Even if the locking systems serve primarily to hold the movable components in their closed position, today there is an increasing emphasis on comfort functions. In this case it is preferably important, in the case of hinged panels, that secure closing and easy opening are ensured.

In this case, engine hoods or hinged panels can be closed by means of a seal, thus providing sealing against water or dirt, for example. In this case, a seal means that, when the lock is being closed, a counter-pressure opposes the locking mechanism as a securing element.

Preferably and generally usual, is that in the case of engine hoods or hinged panels a lock holder is fastened to the engine hood or to the hinged panel, which striker then interacts with the motor vehicle lock. The striker generally interacts with a locking mechanism of the associated motor vehicle door lock. The striker and motor vehicle door lock generally define the motor vehicle door locking means. In conjunction with the locking mechanism in the motor vehicle lock, the striker ensures a secure and reliable closure. In principle, this can also be reversed.

Due to the primary closing function of the striker in conjunction with the locking mechanism in the motor vehicle door lock, it is, on the one hand, a particularly safety-relevant component which, on the other hand, is exposed to particular loads in particular in the event of an accident. In fact, the protection of vehicle occupants in the event of a side impact depends substantially on how reliably the striker and the locking mechanism interacting therewith are capable of absorbing the forces acting thereon. The primary concern here is that the motor vehicle door remains closed so that safety devices provided in or on the motor vehicle door, such as a brake assistant, side airbags, side impact protection, etc., can have the desired effect.

The locking mechanism contained in the motor vehicle lock has a pre-latching or holding or catch position, and a main locking. In the case of hood or hinged-panel locks, two-stroke actuation is provided. By means of a first stroke, which acts on the motor vehicle lock for example via a Bowden cable, the striker is transferred from the main latching position (closed hinged panel) into a pre-latching or catch position. This secures the hinged panel against opening completely, and thus endangering the driver or passengers, in the event of inadvertent actuation of the Bowden cable. Only after a second pull on the Bowden cable is the hinged panel or hood completely released.

A front hinged-panel lock of the type described above is described in DE 296 00 386U1. The front hinged-panel lock interacts with a closing bar. The front hinged-panel lock is usually arranged on the front end of a motor vehicle and interacts with a closing bar of a front hinged panel. The closing bar is pivotably mounted on the front hinged panel and can be pivoted from a normal position into an avoiding position, counter to the restoring force of a closing bar spring. This is achieved with the aid of an actuating handle which can be actuated by the user when the closing bar is in a pre-latching position. The closing bar is then pivoted out of its movement path and can pivot around the hook end. During closing of the closure, the closing bar, and in particular a rib that forms the end of the closing bar, slides along on the control flank of the catch hook, which, in the prior art, is fixedly connected to the lock housing. The catch hook runs over the end of the control flank and is then moved back by the tensioned catch hook spring, such that it assumes a rear engagement position relative to the latching flank. When the closing bar is displaced further, it enters a locking mouth of a rotary latch, which twists in the course of the further displacement of the closing bar and is secured by a pawl in a locking position.

A front hinged-component lock is known from DE 10 2010 061 518 A1, comprising a catch hook assigned to a lock housing for engaging a closing bar, the catch hook comprising a control flank and a latching flank, the latching flank being arranged in the movement path of the closing bar, which can be deflected from its movement path in such a way that, when the front hinged panel is closed, the closing bar initially slides along on the control slope of the catch hook, which is fixed relative to the lock housing in the catching position, and after passing over the catch hook end, enters a pre-latching position behind the latching flank, and further comprising a locking mouth of a pawl, into which the closing bar enters in an open position of the rotary latch after a further displacement of the front hinged panel in the closing direction, and in which the closing bar is held in a locking position of the rotary latch secured by a pawl, the catch hook being fixedly connected to the rotary latch and the rotary latch being pivot-blocked by a spring-loaded ejection arm into its open position, which pivot-blocking is removed by displacement of the ejection arm upon entry of the closing bar into the locking mouth.

The problem addressed by the invention is that of improving the closing performance of the front hinged-panel lock mentioned at the outset.

The object is achieved by the features of independent claim 1. Advantageous embodiments of the invention are specified in the dependent claims. It should be noted that the exemplary embodiments described below are not restrictive; rather, any variation of the features described in the description and the dependent claims is possible.

According to claim 1, the problem addressed by the invention is solved in that a lock for a motor vehicle, in particular a hood lock, is provided, comprising a locking mechanism with a rotary latch and at least one pawl for latching a striker at least in a locking position of the motor vehicle lock, a torsion spring, wherein the torsion spring interacts with the locking mechanism in such a way that the striker can be moved out of the locking position by means of the torsion spring, at least in a supporting manner, wherein a different force can be introduced into the rotary latch by means of the torsion spring. The inventive design of the lock now makes it possible to open and close the lock using different forces on the rotary latch. During the closing process, it must be ensured that the striker securely moves into the main locking position. This can be made particularly difficult by the fact that the hood or hinged panel is counteracted by a force from a seal. This sealing force must be overcome, while at the same time the hood or hinged panel must be closed against the force of the torsion spring. Due to the inventive construction of the lock, a modified, lower force can now be provided in the lock and therefore easy closing is possible. In contrast, when opening the lock, a high force is required to lift the hood, in particular a large and long engine hood, to allow the operator to intervene. The different forces in the vehicle lock enable a selective and situation-dependent provision of force by the torsion spring.

Advantageously, the torsion spring can be brought into direct engagement with the rotary latch. A direct engagement of the torsion spring on the rotary latch enables direct interaction between the rotary latch and the striker. The force can be transmitted from the torsion spring to the rotary latch without a transmission element, so that the force which is variable via the torsion spring can be introduced directly into the rotary latch and is available to the rotary latch.

If the force of the torsion spring is adjustable by means of a pretensioning lever, a further embodiment of the invention can be achieved. The pretensioning lever interacts directly with the torsion spring and is able to adjust the spring deflection. In other words, the force provided by the torsion spring can be varied using the pretensioning lever. The torsion spring has two legs, with a first leg engaging directly with the rotary latch and a second leg engaging with the pretensioning lever. The torsion spring is thus able to brace itself on the pretensioning lever and introduce a force directly into the rotary latch.

The pretensioning lever is pivotally mounted in a lock case of the vehicle lock. Because the pretensioning lever can be moved or pivoted, the abutment of the second leg on the pretensioning lever can be altered. In this way, the force acting on the rotary latch can be varied. By shifting the contact point of the leg of the torsion spring, the spring deflection can be adjusted, thus allowing the force in the torsion spring to be influenced. With different spring deflections, i.e. with different spreading of the spring, a different force can be made available in the vehicle lock. The force is adjustable.

It may furthermore be advantageous if one leg of the torsion spring bears against a bent portion of the pretensioning lever. In order to provide a simple and therefore cost-effective design solution, a bent portion is provided on the pretensioning lever. The second leg of the torsion spring bears against this bent portion. If the pretensioning lever mounted in the lock case is then moved, or preferably pivoted, the spring deflection of the torsion spring, i.e. the spread, changes. When the legs are spread wide, a lower force is exerted on the torsion springs, whereas when the legs are compressed, a high force is present on the torsion spring. Consequently, pretensioning and relieving of the torsion spring can be achieved using the simplest design means.

In order to secure the position of the pretensioning lever, the pretensioning lever can be positioned in at least one position by means of a blocking lever. The pretensioning lever is pivotally accommodated in the lock case. Owing to the torsion spring and the abutment of the second leg, the pretensioning lever is spring-loaded. A blocking lever is used to ensure that the pretensioning lever can be held in different positions. If the pretensioning lever is moved into a pretensioned position, as described below using the rotary latch, the blocking lever is able to secure the pretensioning lever in the tensioned position or to block the movement of the pretensioning lever. The blocking lever is mounted in the lock case and can be brought into engagement at least with the pretensioning lever.

In order to be able to hold the blocking lever securely in the tensioned position, it may be advantageous if the blocking lever can latch into a recess in the pretensioning lever. Through this further simple design option for ensuring coordinated interaction between the pretensioning lever and the blocking lever, it is possible to achieve precise positioning and also ensure that the pretensioning lever is securely held.

If the blocking lever can be actuated by means of the rotary latch, a further embodiment of the invention can be achieved. As described above, the rotary latch interacts with a pawl and, together with the pawl, forms the locking mechanism. In the main locking position of the locking mechanism, the rotary latch is in a maximally retracted position in the rest position, regardless of an overtravel position during latching. If this position of the rotary latch, or more precisely the attainment of the main locking position is used to pretension the pretensioning lever, the pretensioning lever can be pretensioned using the simplest design means. The rotary latch is closed or moved to its main locking position, and at the same time the pretensioning lever is moved to a tensioned position. In this pretensioning position, the blocking lever is then simultaneously brought into engagement with the pretensioning lever, in particular by means of a spring load. The final closing in the main locking position is therefore used to pretension the torsion spring.

It may furthermore be advantageous if the blocking lever has a first arm that can be brought into engagement with the pretensioning lever and a second arm that can be brought into engagement with the rotary latch. In this case, the rotary latch assumes a dual function. Firstly, the rotary latch cooperates with the pawl in the sense of a locking mechanism and secures the hood or hinged panel. Secondly, the rotary latch controls the pretensioning of the pretensioning lever by interacting with the blocking lever. The blocking lever can be moved out of engagement with the pretensioning lever by means of the rotary latch, thus releasing the pretensioning lever.

The solution to the problem can also be provided by a method for closing a motor vehicle lock, in which the rotary latch is subjected to the force of a torsion spring, and the torsion spring is subjected to a large force when the lock is opened and to a smaller force when the lock is closed. It is thus possible to achieve easy closing and opening assisted by high force.

The invention is explained in more detail below with reference to the accompanying drawings on the basis of a preferred exemplary embodiment. However, the principle applies that the exemplary embodiment does not limit the invention, but merely represents one embodiment. The features depicted can be implemented individually or in combination with further features of the description as well as what is claimed-individually or in combination.

### In the Figures:

FIG. 1 shows a motor vehicle lock according to the invention, shown only partially in a side view, in a closed position, that is to say, in a main locking position,

FIG. 2 shows the lock according to FIG. 1 in a lift-off position, i.e. a pre-latching position,

FIG. 3 shows the lock according to FIG. 1 in a further opened lift-off position, i.e. a position beyond the pre-latching position during the opening process and

FIG. 4 shows the lock according to FIG. 1 in a fully open position.

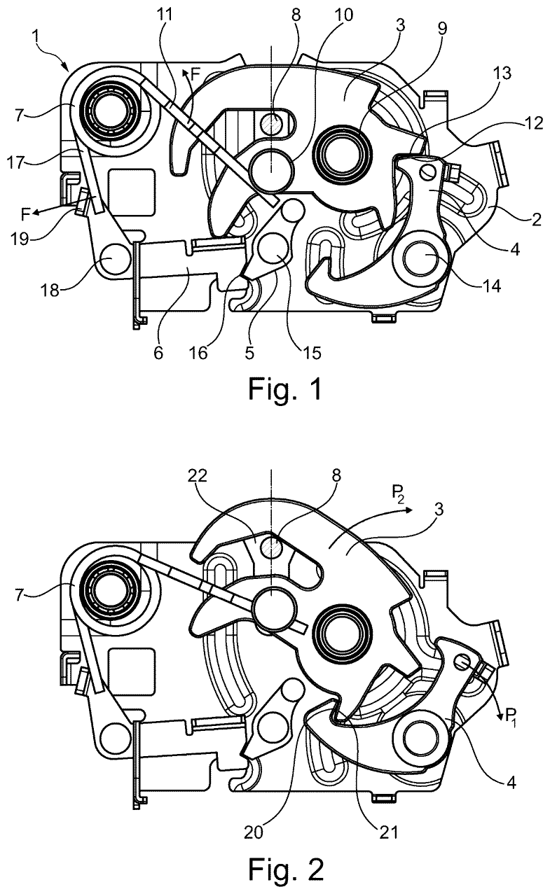

FIG. 1 shows a motor vehicle lock 1 in part. The lock 1 comprises a lock case, a rotary latch 3, a pawl 4, a blocking lever 5, a pretensioning lever 6 and a torsion spring. A striker 8 is held by means of the rotary latch 3 and secured in its position, wherein the illustrated position of the striker 8 corresponds to a closed position of an engine hood (not illustrated). The engine hood is held in the closed position by means of the striker 8 in interaction with the motor vehicle lock 1.

The rotary latch 3 is pivotally accommodated or mounted in the metallic lock case 2, wherein the rotary latch 3 is pivotally mounted about a pivot shaft 9. The rotary latch 3 further comprises a bolt 10, wherein the bolt 10 interacts with a first leg 11 of the torsion spring 7. The torsion spring 7 and in particular the first leg 11 acts on the rotary latch 3 with a force F which, with respect to the rotary latch 3, acts in the clockwise direction.

The rotary latch 3 is held or secured in the main locking position shown in FIG. 1 by means of a pawl 4. For this purpose, the pawl 4 is spring-loaded in the direction of the rotary latch 3 by means of a spring (not shown). To hold or position the rotary latch 3, the pawl 4 engages, with a first locking contour 12, into the main locking 13 of the rotary latch 3.

The blocking lever 5 interacts with the pretensioning lever 6 and blocks the pretensioning lever 6 in the main locking position of the motor vehicle lock 1. The blocking lever 5 secures the position of the pretensioning lever 6 so that pivoting of the pretensioning lever 6 in the counterclockwise direction can be prevented. The blocking lever 5, like the pawl 4 and the rotary latch 3, is pivotally mounted in the lock case 2; a pivot shaft 9, 14, 15 is provided in each case.

The blocking lever 4 engages on one side in a recess 16 of the pretensioning lever 6 and secures the position of the pretensioning lever 6. The pretensioning lever 6, in turn, is spring-loaded via the second leg 17 of the torsion spring 7 and, like the other movable components 4, 5, 6, is pivotably held in the lock case 2 by means of a pivot shaft 18. The torsion spring 7 also applies a force F to the pretensioning lever, the force F acting on the pretensioning lever 6 in counterclockwise direction.

In FIG. 1, the spring 7 is maximally preloaded and held between the bolt 10 and a bent portion 19 of the pretensioning lever 6. In this position of the spring 7, a maximum force can therefore be exerted on the rotary latch 3. The pretensioning force on the rotary latch 3 supports the rotary latch 3 in the opening process described below.

If, as shown in FIG. 2, the pawl is moved out of its main locking position, for example by means of a Bowden cable acting in the direction of arrow P1, the rotary latch 3 is released and is moved clockwise in the direction of arrow P2 by means of the torsion spring 7. However, the rotary latch 3 is not completely released but is held in an intermediate locking position 21 by means of a second locking contour 20 on the pawl 4, for as long as traction is applied to the Bowden cable or the pawl 4. The striker 8 is therefore not released but is held in the inlet mouth 22 of the rotary latch 3. The torsion spring 7 holds the rotary latch 3 in the partially open intermediate position, as shown in FIG. 2.

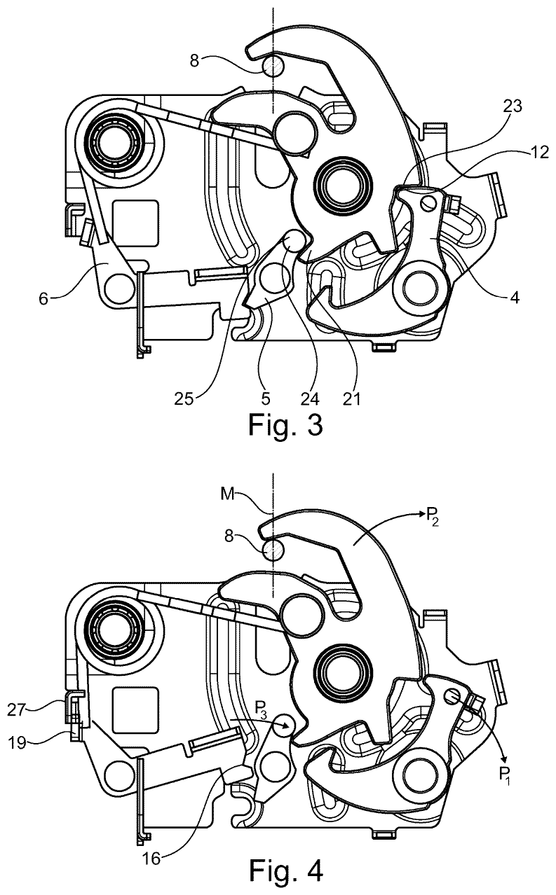

If the Bowden cable is subsequently relieved, i.e. if the first pulling on the Bowden cable is stopped, the pawl re-engages with the first locking contour 12 into the pre-latching contour or pre-latch 23 of the rotary latch 3, as shown in FIG. 3. It should now be noted that the intermediate locking contour 21 on the rotary latch 3 engages with a further arm 24 or a bolt 25 on the blocking lever 5. In FIG. 3, the intermediate locking contour 21 bears against the blocking lever 5. Furthermore, it is important that the torsion spring 7 continues to be pretensioned by means of the second leg 17. In other words, the torsion spring 7 continues to exert a large force on the rotary latch 3, thus supporting and facilitating opening of the hood. The blocking lever 5 is spring-loaded in a clockwise direction, i.e. in the direction of the rotary latch 3, by means of a torsion spring (not shown).

If, starting from FIG. 3, the Bowden cable is actuated again, as shown in FIG. 4, two movements occur simultaneously. On the one hand, the rotary latch 3 is released and can move freely clockwise in the direction of the arrow P2 and on the other hand, the blocking lever 5 is moved and releases the pretensioning lever 6. The rotary latch 3 moves the blocking lever 5 counterclockwise so that the further arm 26 of the blocking lever 26 is moved out of the recess 16 of the pretensioning lever 6. The second leg 17 now comes to rest against a stop 27 on the lock case 2. The bent portion 19 on the pretensioning lever likewise bears against the stop 27 of the lock case 2. As soon as the rotary latch 3 has reached its end position, the striker is released and can be freely moved linearly along the line M. In other words, the striker 8 and the hood can be opened.

A further advantage of the invention is apparent here. When the motor vehicle lock 1 is in the opened state, the spring 7 is in a maximally relaxed condition and exerts only a small force on the rotary latch 3. This offers the advantage that the hood can be easily closed and moved into the main locking position. In contrast, starting from the main locking position, the torsion spring 17 introduces a maximum force F into the rotary latch 3 and thus into the striker 8, as a result of which the hood can be easily opened, lifted and safely transferred into the pre-latching or catch position. In other words, the rotary latch is subjected to a high force F by the compressed spring 7, thus enabling assisted opening of the hood. In the open position of the hood, and thus in the open, unlocked position of the motor vehicle lock 1, the spring 7 is in a maximally relaxed condition, and therefore the rotary latch 3 is only subjected to a small counterforce F. The hood can therefore be opened easily and closed with little resistance.

### LIST OF REFERENCE SIGNS

1 Motor vehicle lock
2 Lock cases
3 Rotary latch
4 Pawl
5 Blocking lever
6 Pretensioning lever
7 Torsion spring
8 Striker
9, 14, 15, 18 Pivot shaft
10,25 Bolt
11 First leg
12 First locking contour
13 Main locking
16 Recess
17 Second leg
19 Bent portion
20 Second locking contour
21 Intermediate locking contour
22 Inlet mouth
23 Pre-latch
24,26 Arm
F Force
P1, P2, P3 Arrow
M Line

1. A lock for a motor vehicle, in particular a hood lock, comprising a locking mechanism having a rotary latch and at least one pawl for latching a striker at least in a locking position of the motor vehicle lock, and a torsion spring, wherein the torsion spring interacts with the locking mechanism such that the striker can be moved out of the locking position by means of the torsion spring, at least in a supporting manner, wherein different force can be introduced into the rotary latch means of the torsion spring.

2. The motor vehicle lock according to claim 1, wherein the torsion spring can be brought into direct engagement with the rotary latch.

3. The lock according to claim 1, wherein the force of the torsion spring is adjustable by means of a pretensioning lever.

4. The lock according to claim 1, wherein the pretensioning level is pivotably mounted in a lock case.

5. The lock according to claim 1, wherein one leg of the torsion spring bears against a bent portion of the pretensioning lever.

6. The lock according to claim 1, wherein the pretensioning lever can be held at least in one position by means of a blocking lever.

7. The lock according to claim 6, wherein the blocking lever can latch into a recess.

8. The lock according to claim 6, wherein the blocking lever can be actuated by means of the rotary latch.

9. The lock according to claim 6, wherein the blocking lever comprises a first arm which can be brought into engagement with the pretensioning lever and a second arm which can be brought into engagement with the rotary latch.

10. A method for closing a motor vehicle lock according to claim 1, in which the rotary latch is subjected to the force of a torsion spring and the torsion spring is subjected to a large force when the lock is opened and to a smaller force when the lock is closed.
